(19) United States
(12) Patent Application Publication
(10) Pub. No.: US 2010/0266188 A1
(43) Pub. Date: Oct. 21, 2010

(54) CHEST X-RAY REGISTRATION, SUBTRACTION AND DISPLAY

(75) Inventors: Richard V. Burns, Beavercreek, OH (US); Jason F. Knapp, Miamisburg, OH (US); Tripti Shastri, Cedar Park, TX (US); Steve W. Worrell, Springboro, OH (US)

Correspondence Address: CONNOLLY BOVE LODGE & HUTZ LLP, 1875 EYE STREET, N.W., SUITE 1100, WASHINGTON, DC, 20006, US

(73) Assignee: RIVERAIN MEDICAL GROUP, LLC, Miamisburg, OH (US)

(21) Appl. No.: 12/425,681

(22) Filed: Apr. 17, 2009

(51) Int. Cl. G06K 9/00

(52) U.S. Cl. 382/132

(57) ABSTRACT

Images may be registered by performing a number of operations that may include coarse alignment, coarse registration, and fine registration. The finely-registered images may be subtracted to obtain a residual image.

### BACKGROUND

Radiographic imaging for medical purposes is well known. Radiographic images of the chest, for example, may provide important diagnostic information for detecting and treating a large number of medical conditions involving the lungs, bony structures in the chest, the upper abdominal organs, the vascular structures of the lungs, and the disc spaces of the mid-thoracic spine.

Because of the great advantages provided by digital images, radiographs are typically stored and manipulated in digital form. Digital radiographs may be created either by direct capture of the original image in digital form, or by conversion of an image acquired by an “analog” system to digital form. Digital images simplify record keeping, such as in matching radiographs to the correct patient, and allow for more efficient storage and distribution. Digital images also allow for digital correction and enhancement of radiographs, and for application of computer-aided diagnostics and treatment.

Once in a digital format, various techniques may be utilized to enhance the utility of radiographic images. One such technique is segmentation. Segmentation involves separating objects (for example, the background from the foreground) or extracting anatomical surfaces or structures from images for the purposes, for example, of diagnosis, evaluation, or measurement. Segmentation may be valuable to tasks such as visualization and registration for temporal comparisons.

Other techniques may help to enhance the conspicuity of features of interest in radiographic images while suppressing extraneous elements. A common problem encountered in the use of radiographs is that various structures within the body may overlie one another, which may result in important features being obscured by other structures situated above or below them. For example, details within the soft tissue of the lungs may be difficult to interpret in a radiograph due to the superimposed images of the patient's ribs. Bone suppression techniques, such as the SoftView® system developed by Riverain Medical Group, LLC (the assignee of the present application), may increase the clarity of soft tissue in digital radiographic images by essentially removing bone images.

Image registration is the process of aligning separate images for facilitating comparisons and medical diagnosis. Registration may aid doctors in visualizing and monitoring physiological changes in a patient over time. For example, registration may help doctors monitor the growth or shrinkage of a lesion or nodule and may aid in the detection of subtle changes in density over time.

Registration of radiographic images taken of a patient at different times may be difficult because the patient's alignment to the imaging device may not be perfectly replicated, because the acquisition device may have different imaging parameters (e.g., sampling, exposure, contrast response functions, etc) and/or because differences within the patient (both clinically relevant and irrelevant) may be present. In chest radiographs, for example, images taken at different times may be out-of-phase with respect to the patient's breathing, resulting in different positions of the diaphragm. Also, changes in the patient's medical condition, e.g., lung disease, such as pneumonia, etc., may lead to changes in appearance of the lung field, complicating image matching.

Registration of radiographic images may also be problematic because different structures within the images may not be strongly coupled together and may, therefore, move differently between images taken over a span of time. Radiographic images in which the ribcages are accurately registered, for example, may differ with respect to details in the soft tissues of the lungs. The lung structure (particularly internal) is only loosely coupled to the rib cage.

A further image processing technique, once radiographic images have been registered, may be to generate a “residual” image representing the differences between the images. A residual image may be formed by subtracting one image from another. In a perfectly normalized and registered residual image, those portions of the two images that are identical, both with respect to morphology and tissue type, should perfectly subtract. On the other hand, if the morphology and/or absorption properties are different, this may be quite apparent in the residual image. Differences between the two images may appear as either dark or light features, illustrating changes between images taken over an interval of time. Therefore, it may present problems if features of interest in the radiographs are not accurately registered and normalized.

Existing techniques for aligning and registering radiographic images may fail to account for the decoupling of bone structures and soft tissue and typically cannot provide clear depictions of soft tissue changes.

### SUMMARY

Embodiments of the invention may include methods that may perform rigid alignment and multi-scale, iterative, non-rigid registration of radiographic images; the transforms may be generated on and subsequently applied to layers of derived images, in which each image may suppress all but one tissue type, such as bone, muscle, or lung parenchyma. The residual image may preferentially weight or omit information from a multi-scale decomposition to enhance conspicuity of relevant features while simultaneously suppressing others.

Various embodiments of the invention may be in the forms of methods, apparatus, systems, and/or computer-readable media containing processor-executable instructions to execute methods. It is further noted that it is anticipated that such methods may be performed by an automated processing device, for example, but not limited to, an image processing device, by a general purpose processor or computer, etc.

### BRIEF DESCRIPTION OF THE DRAWINGS

FIG. 1 is a flow diagram providing an overview of embodiments of the invention;

FIG. 2 is a flow diagram providing additional detail of pre-processing according to some embodiments of the invention;

FIG. 3 is a flow diagram providing additional detail of coarse alignment according to various embodiments of the invention;

FIG. 4 further illustrates how tilt between the current and prior images may be determined from the ribcage segmentation;

FIG. 5 is a flow diagram providing additional detail of coarse registration according to various embodiments of the invention;

FIG. 6 further illustrates how coarse registration may be accomplished utilizing the current and prior bone images;

FIG. 7 illustrates the optical flow in a fine alignment process according to an embodiment of the invention;

FIG. 8 shows an example of a residual image that may be obtained by coarse alignment;

FIG. 9 shows an example of a residual image that may be obtained after coarse registration;

FIG. 10 shows an example of a residual image that may be obtained after fine alignment;

FIG. 11 is an example of a residual image of registered “complete” current and prior images, including both bone and soft tissue;

FIG. 12 is an example of a corresponding residual image of bone-suppressed current and prior registered images;

FIG. 13 is an example of a residual image of bone-suppressed current and prior registered images with irrelevant information from decomposition pyramids, which may be used in some embodiments of the invention, omitted;

FIG. 14 is a flow diagram of a post-processing blending process that may be used in some embodiments of the invention; and

FIG. 15 illustrates a conceptual block diagram of a system in which all or a part of various embodiments of the invention may be implemented.

### DESCRIPTION OF EMBODIMENTS OF THE INVENTION

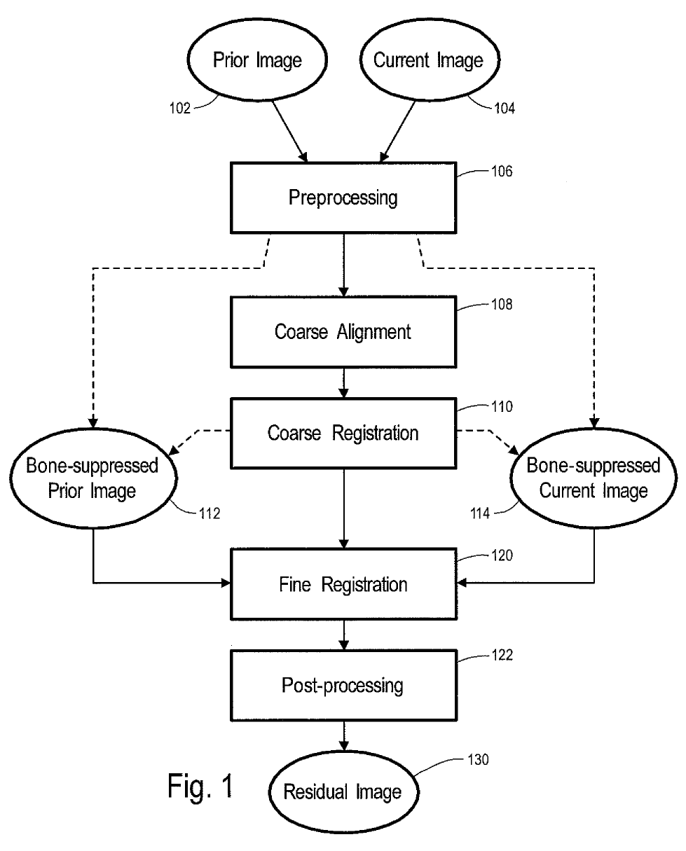

FIG. 1 is a flow diagram providing an overview of embodiments of the invention. Embodiments of the invention may begin with a previous radiographic image 102 of a patient and a new, current radiographic image 104 of the patient. Even though the two radiographic images may have been obtained utilizing the same or identical equipment and care taken to insure that the alignment of the patient to the equipment was as consistent as possible, the two images will often differ in orientation and in the positions of the internal structures depicted.

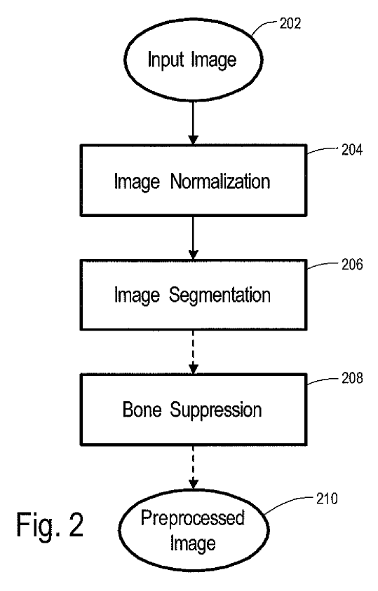

Embodiments of the invention may proceed by preprocessing 106 the prior and/or current images. Preprocessing may, according to some embodiments of the invention, proceed according to the further detail in FIG. 2. Each input image 202 may first be normalized 204, for example, such that the two images have uniform sampling functions, in terms of pixels per unit length; uniform bit depths, in terms of bits per pixel; uniform image contrast; and reduced noise levels. Normalization may thus provide images having uniform characteristics, such that an identical feature in the two images, if properly aligned, may essentially “cancel” if one image were subtracted, pixel per pixel, from the other image.

After normalization, preprocessing may continue with segmentation 204 of the images. Segmentation may, for example, delineate the lungs, the rib cages, or other structures in the two images for subsequent processing. Bone-suppression 208 may also occur during preprocessing, as discussed below, and preprocessing then ends 210, with preprocessed images available for subsequent processing.

Outputs of the preprocessing step 106 may also include a bone-suppressed prior image 112 and a bone-suppressed current image 114, such as may be generated, for example, by the SoftView® system developed by Riverain Medical Group, LLC, presented in part in U.S. patent application Ser. No. 12/246,130, filed Oct. 6, 2008, entitled, “Feature Based Neural Network Regression for Feature Suppression,” commonly-assigned and incorporated herein by reference. Alternatively, the bone-suppressed images may be generated at a later stage of processing, such as, for example, after coarse registration 110 of the images. Bone images, which suppress soft tissue, may also be generated for use in coarse registration of the images, as described below.

After preprocessing, embodiments of the invention may continue with coarse alignment 108 of the two images. Coarse alignment 108 may be used to correct for offset (translation) and/or tilt (rotation) between the two images and/or to roughly align the images such that subsequent registration steps 110, 120 may be more effective. Embodiments of coarse alignment 108 may assume that the prior and current images are already within a certain tolerance afforded by the radiographic process, such as, for example, within 36 mm in vertical alignment. Coarse alignment 108 may utilize lower resolution versions of the prior and current images, such as, for example, images with a pixel resolution of 3 mm per pixel. Further, embodiments for coarse alignment 108 may be implemented using an affine transformation for computing rigid coordinate axis transformations.

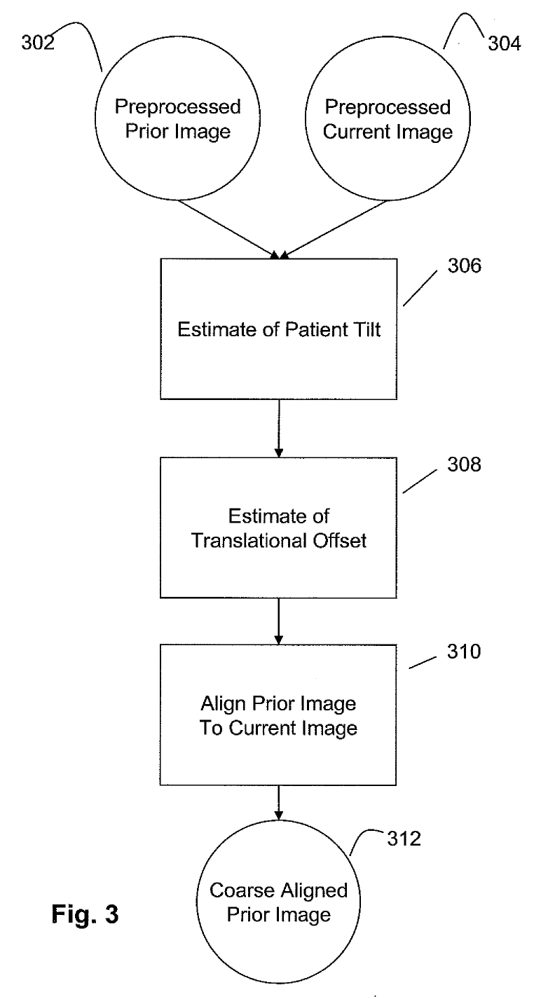

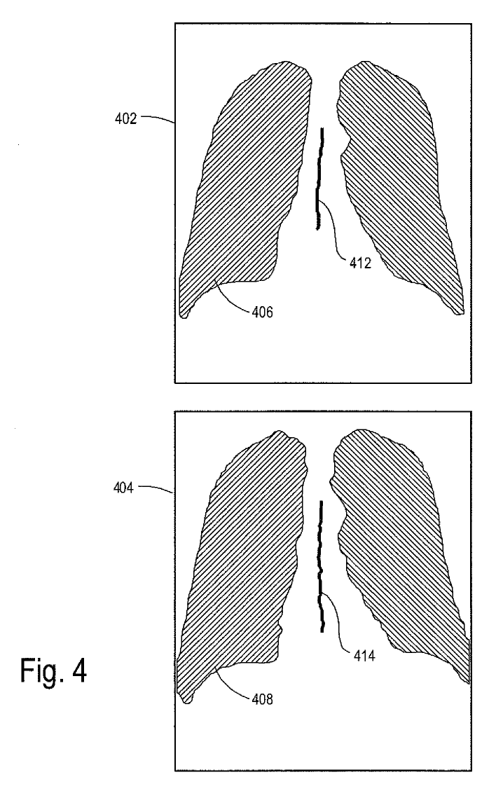

As depicted in FIG. 3, embodiments of coarse alignment 108 may begin 302 with the generation of a low-resolution estimate of patient tilt 304. One exemplary method of determining patient tilt is shown in FIG. 4. A ribcage segmentation 402, 404 of each image, such as may be obtained from the preprocessing 106, may be analyzed to calculate a midline 412, 414 of the ribcage; exemplary techniques may be found in U.S. patent application Ser. No. 12/252,615, filed Oct. 16, 2008, commonly-assigned, and incorporated by reference herein. The endpoints, or apices, of each midline may be used to determine the relative tilt between the two images.

In an embodiment of the invention, tilt between the two images may be corrected by adjusting the prior image to have the same tilt as the current image. An estimate of the translation offset 306 between the two images may then be generated. One method of determining the offset, for example, is to determine the grayscale correlation between the two images. The ribcage segmentations may be used to constrain correlation, in that only the grayscale features falling within the segmentations (the cross-hatched areas of FIG. 4) may be used. This may serve to eliminate extraneous contributions to the correlation from features outside the ribcage.

In an embodiment of the invention, correction of translational offset may be achieved by aligning the prior image to the current image 310, and coarse alignment ends 312. Both coarse tilt and coarse translational adjustments may be applied globally to the prior image, in that localized effects within the images may not be considered. In an embodiment of the invention, coarse alignment may bring localized effects within approximately 15 mm of each other.

After coarse alignment 108 is complete, a coarse registration 110 may be performed. In coarse registration 110, a localized correlation may be performed on the images about specific points, and localized elastic transformations may be applied.

In one embodiment of the invention, coarse registration 110 may be performed using bone images derived from the current and prior images, with soft tissue features suppressed. In another embodiment, a soft tissue image with the bone features suppressed may be used to compute the correlation between localized regions in coarse registration 110. Such bone images and/or soft tissue images may be hardware- and/or software-derived.

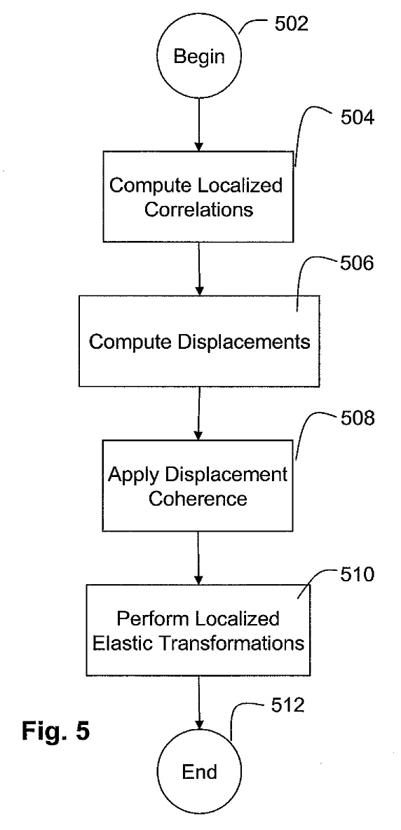

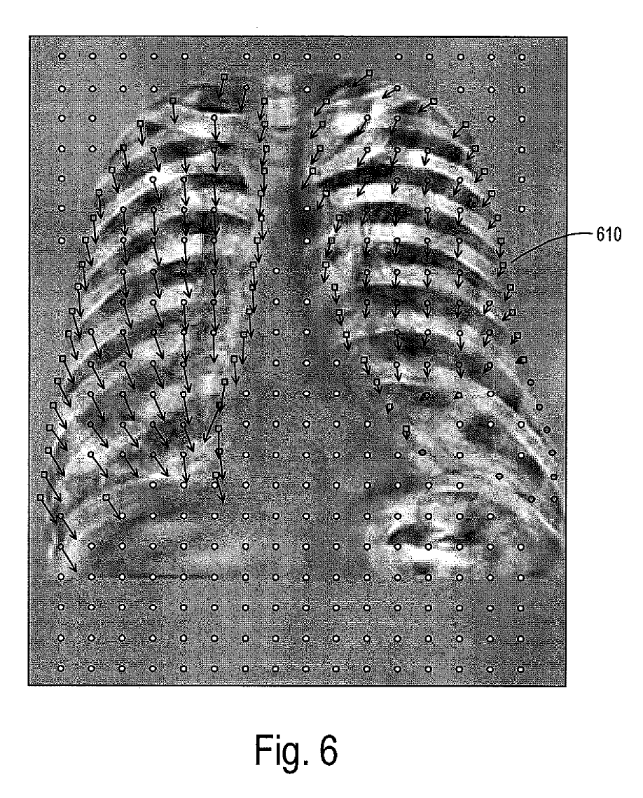

In an embodiment of the invention as further shown in FIGS. 5 and 6, coarse registration 110 may begin 502 by computing localized correlations 504 of the current and prior images. The current and prior images may be divided into localized regions, each depicted by a circle or square in FIG. 6. Within each localized region, correlation may be determined 504 about the center point. Displacements may be computed 506 for each center point, as represented by arrows in FIG. 6 (the lengths of the arrows may be shown exaggerated for illustrative purposes).

In embodiments of the invention, the correlated images may be the raw grayscale images, images that have been contrast enhanced, or images that have been otherwise filtered to bias the correlation to correlate structural elements of interest. Also in an embodiment of the invention, localized regions that do not result in any displacement that gives a sufficiently high correlation (which may, for example, be determined by comparison with a predetermined minimum acceptable correlation value) may inherit a displacement value from neighboring regions. The missing displacement value may be interpolated or extrapolated from known neighboring values.

In embodiments of the invention, the points symbolizing the localized regions may be determined by the location of prominent features such as, for example, peaks in a Difference of Gaussian filter. In one embodiment, localized regions may be determined by a uniformly spaced grid of regions supplemented by additional points of the perimeter of the segmented lung regions. When supplementing the uniform grid, any time two points are too close to one another, one point may be removed, and preference may be given to a lung perimeter point when one of the two points is a lung perimeter point.

In some embodiments of the invention, correlation may be used to determine candidates for the local displacements. However, in addition to the maximum peak in the correlation zone, sufficiently strong non-maximum peaks may also be considered. Selection of the displacement may be determined using a discriminant function of, for example, residual grayscale error in a neighborhood of the candidate location, distance from an expected location, and/or the correlation value itself.

Coherency (consistency in displacement vectors) may be applied 508 to the displacements, and localized elastic transformation 510 of the prior image may be performed. Coherency 508 is a process that may be used to maintain a smooth transformation of the image by making sure that adjacent regions are displaced in a similar way. The coherency process 508 may prevent one portion of the image from folding over another. It may also limit the amount of stretching that can occur between neighboring points.

Once coarse alignment 108 and coarse registration 110 have been performed, the transformations derived from coarse alignment 108 and coarse registration 110 may be applied to the original “bone-suppressed” or soft tissue images 112, 114 that were generated during preprocessing 106. Repeated transformations of the same image may be a lossy process due to grayscale interpolations at each step. Therefore, the transformations may be accumulated in reference to the original image.

Various computational techniques may be used to improve the alignment of images, including methods developed for optical flow estimation between two image frames. One common method is the Lucas-Kanade method, which may break an image into small windows and may assume that the flow is constant within each window (“locally constant flow”). This method may further assume that the intensity of objects within the images remains essentially constant between the images.

When applied to image registration, the Lucas-Kanade method may be applied in an iterative manner. The images may first be decomposed into a scale-space “pyramid”, and the method may be applied to the coarse component of the pyramid; the result from the coarse level may then be used as an estimate for applying the algorithm to successively finer scales of the pyramid.

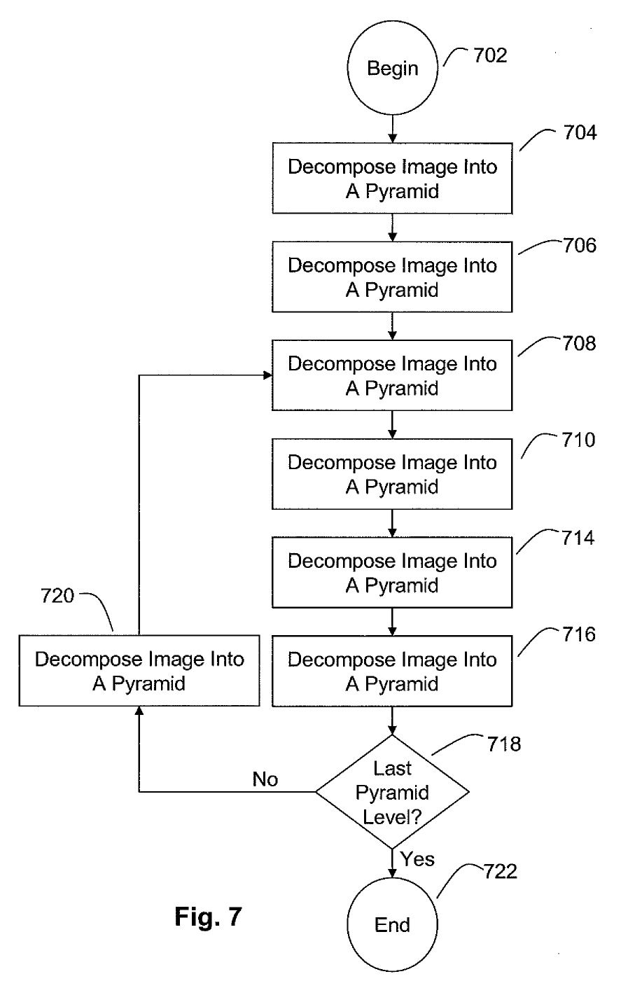

Following coarse registration 110, fine registration 120 may then be performed on the bone-suppressed (or soft tissue) images. A number of techniques may be used for fine registration, including correlation-based methods, and “optical flow” methods, such as are known in the art. One embodiment of the invention utilizes the Lucas-Kanade optical flow method, as discussed above and as illustrated in FIG. 7. Embodiments of the invention may use localized correlations about specific points that may be more densely spaced than in the coarse registration 110.

The optical flow method shown in claim 7 may begin 702 with the multi-scale decomposition of the images into image “pyramids” 704, where each level of the pyramids may represent information from the images at a particular scale or range of spatial frequencies. The first level of the pyramid may represent the lowest spatial frequencies. The displacement estimates may be initialized 706, e.g., at zero. A spatial gradient matrix “G” may be computed 708 for this pyramid level; the image differences may be estimated 710; the mismatch vector “b” may be computed 714; and displacement may be solved for 716. The displacement may be propagated 720 to a next pyramid level (having finer spatial detail); once the pyramid levels comprising the highest spatial frequencies are reached 718, the method may end 722.

After fine registration 120 of the images, subtraction 122 of the current and prior bone-suppressed images may then be used to generate a residual image 130. The residual image 130 may essentially be the difference between the two registered images, obtained by subtracting, pixel value by pixel value, one image from the other. The residual image 130 may be displayed or printed for inspection.

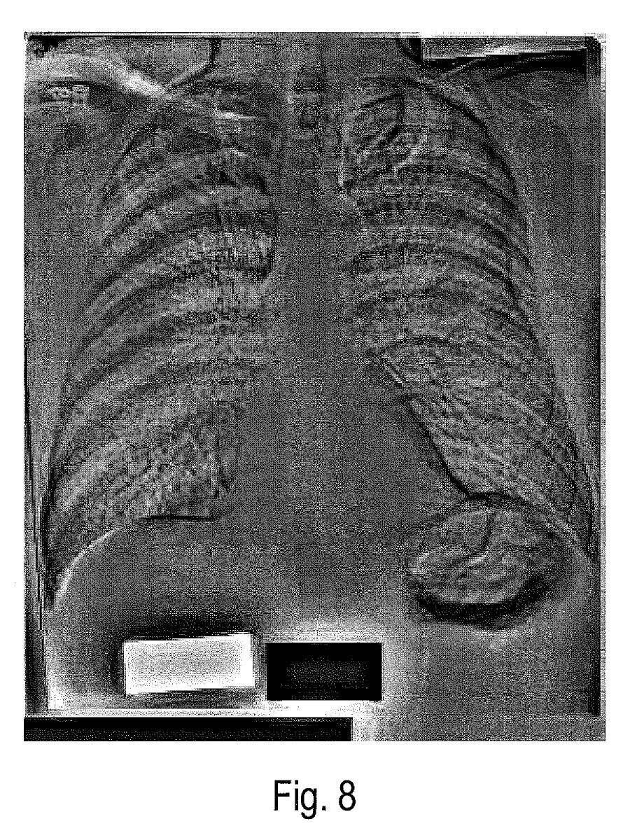

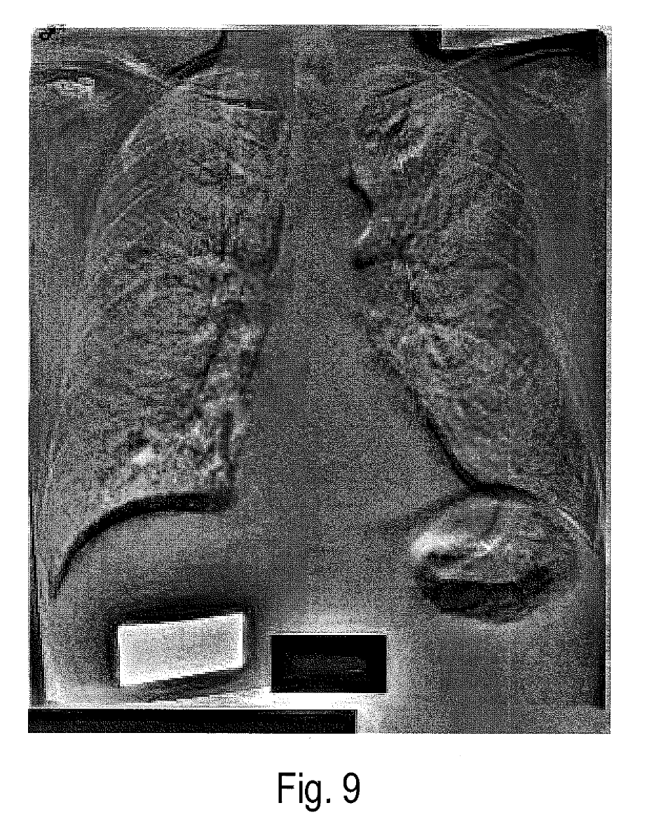

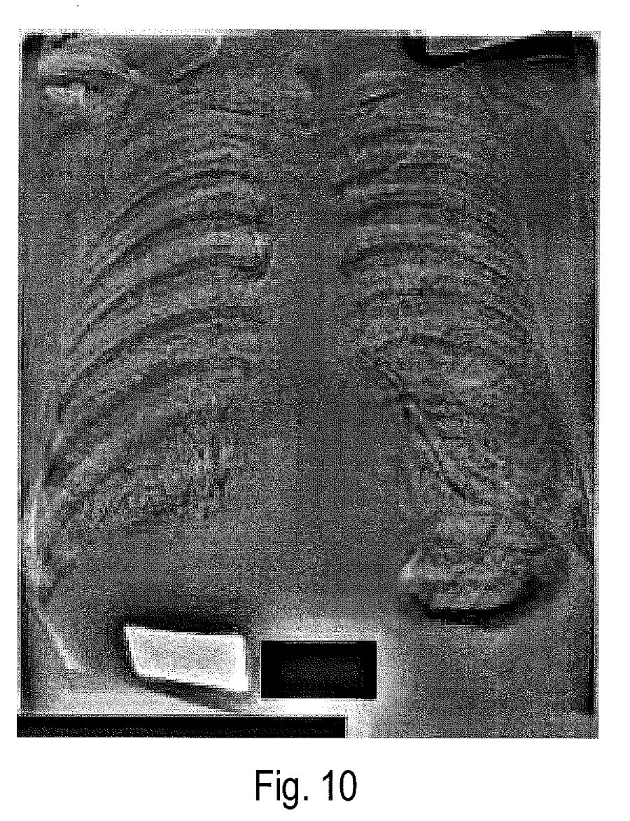

FIG. 8 shows an example of a residual image that may be obtained by the coarse alignment 108. It may be noted that the delineated ribcage is well aligned, although the individual ribs are not. FIG. 9 shows an example of a residual image that may be obtained after coarse registration 110. At this point, both the delineated ribcage and the individual ribs appear well aligned; the soft tissue, and particularly the diaphragm and nodule on the lower right, are not aligned. FIG. 10 shows an example of a residual image that may be obtained after fine registration 120; it can be observed that the soft tissue between the ribs now appears much “cleaner”, and that the diaphragm and nodule are well aligned.

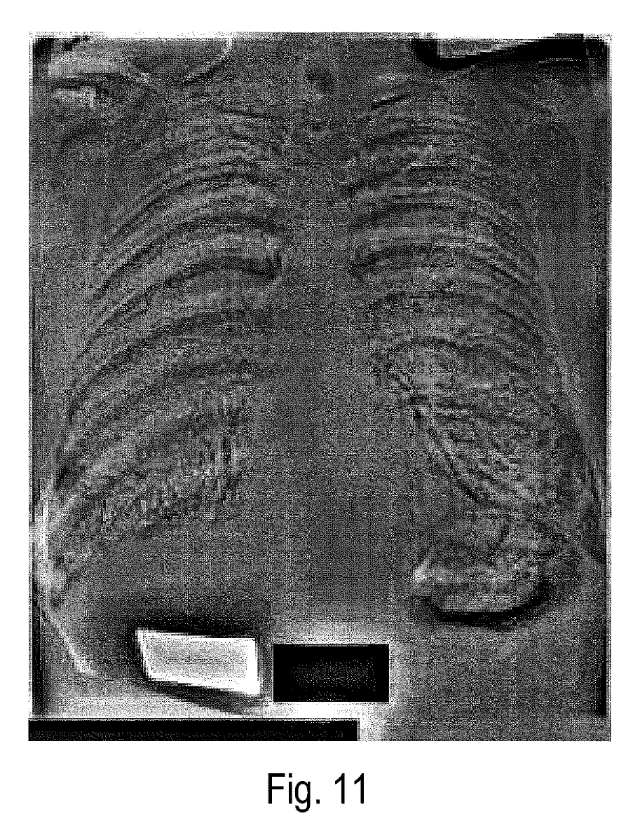

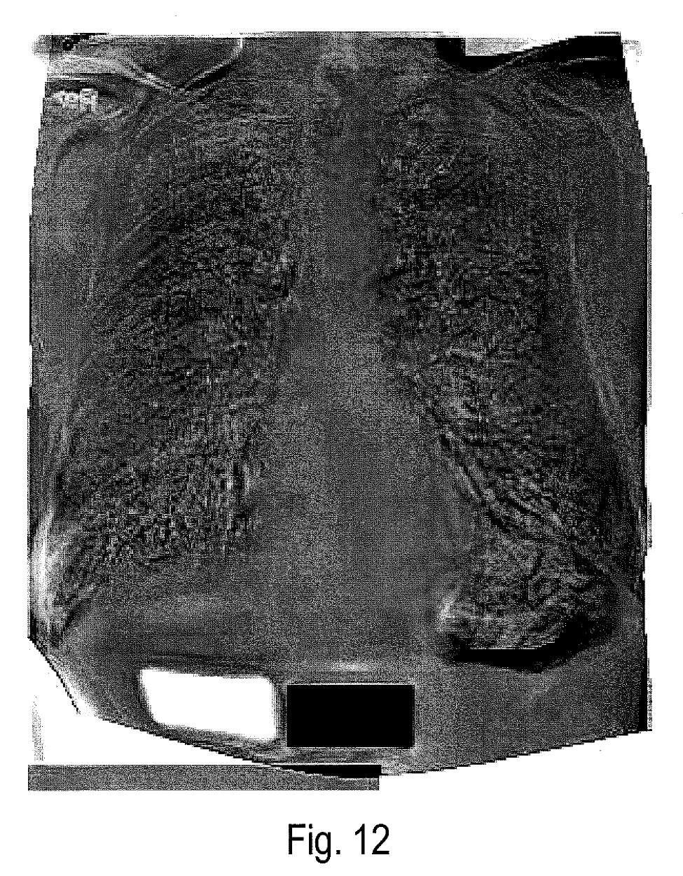

FIG. 11 is an example of a residual image of registered “complete” current and prior images, including both bone and soft tissue. It may be observed that registering the soft tissue resulted in the ribs being out of alignment. FIG. 12 is an example of a corresponding residual image of bone-suppressed current and prior registered images, such as those produced by the SoftView® system developed by Riverain Medical Group, LLC.

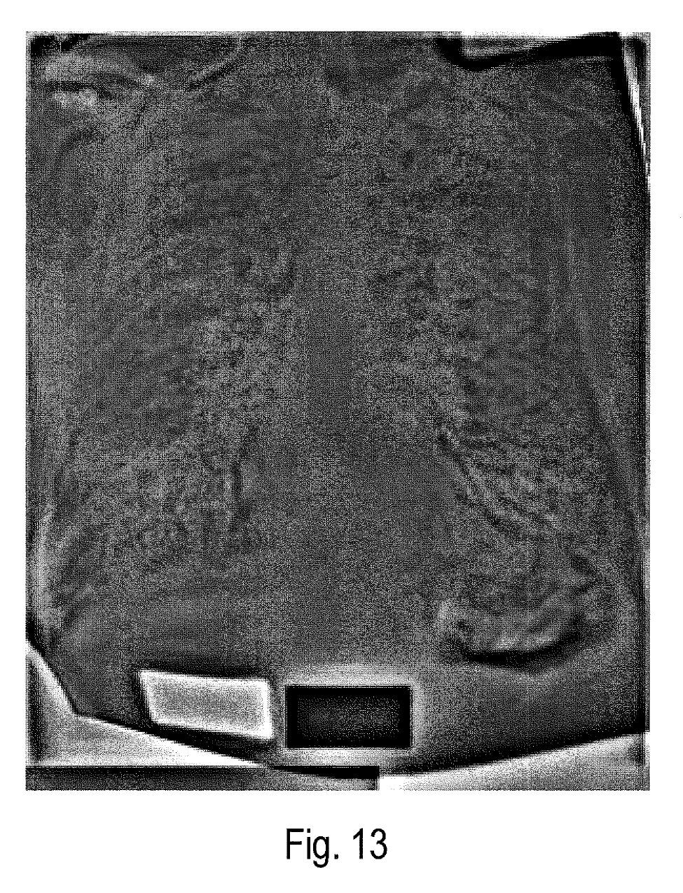

Post-processing 122 may add further processing of the residual image. For example, layers of the multi-scale decomposition may be preferentially weighted or omitted from the residual image to improve the image display to the user. The complete residual image may contain noise and an irrelevant level of detail; omitting levels from the final residual image, as seen in the example of FIG. 13, may assist in interpreting the image.

Post-processing 122 may also include suppressing detail in areas known to be subject to misalignment. Rather than showing the user regions with high error due to limitations of the registration model, detail in those areas may be suppressed, and regions having a higher confidence of correct registration, and therefore more confidence that the residual is meaningful with respect to anatomical, clinically relevant change, may be emphasized. For example, embodiments of the invention have been shown to behave well in the apex area of the lungs, a region that is quite complex and subject to oversight, while known to contain a disproportionate number of cancers.

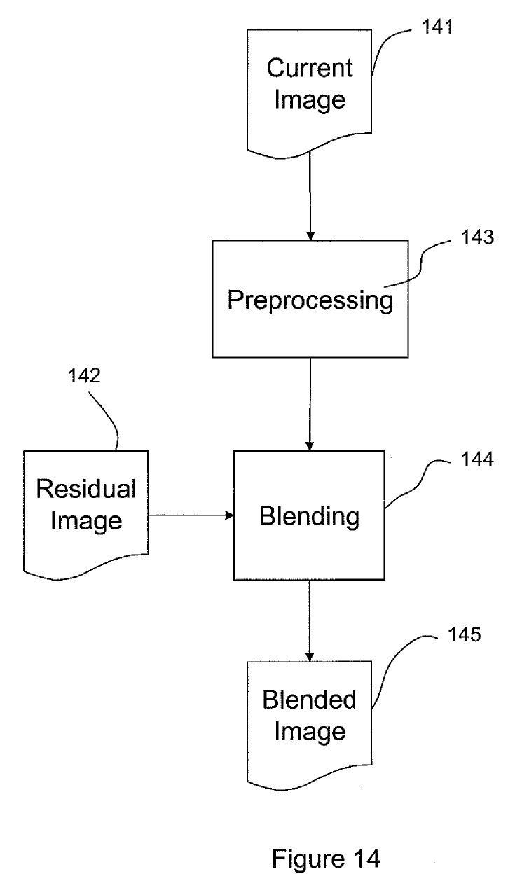

In formation of the display image, the enhanced residual image may be blended with the current image. An embodiment of this is shown in FIG. 14. Since very little structure may be present in a well registered image, such blending may place the lung region of the residual image in a frame of reference the physician is accustomed to looking at. By blending the segmented processing area into the current image, residuals due to artifacts that may exist outside of the chest, for reasons such as flash tags and adjacent anatomy that are not accounted for in the registration process, may be removed. In embodiments of the invention, as shown in FIG. 14, blending the residual image 142 into the current image 141 may begin with preprocessing 143 of the current image 141. In this preprocessing 143, the current image may be locally trend corrected, and its dynamic range may be compressed to produce a more evenly distributed intensity across the whole image. The trend correction may be accomplished, for example, by using wavelet decomposition and then leaving the larger scales out of the reconstruction. The smaller scales may also be left out to remove some high frequency speckle in the image. The dynamic range of the image may then be reduced and centered, for example, at 0.5. This may serve to align the opaque region closely with the expected residual value in that region. Further, a swath of pixels in the lower opaque region of the opaque region of the segmented chest region may be used to compute an offset between the opaque region of the current image and the opaque region of the residual image. The intensity of the current image may be shifted by this offset to make the mean of each region equal, or nearly so.

Once the two images have been prepared for blending, they may then be blended together 144. Blending 144 may begin by defining a distance over which the blending 144 will occur. In one exemplary embodiment, that distance is 10 mm, but the invention is not thus limited. Also in an embodiment, a distance transform may be used to determine the distance from the edge of the segmented lung, and a Gaussian-shaped exponential function may be computed over that span to determine the relative weights of each image. The two images may then be averaged together at every pixel according to their relative weights at each pixel location to form the blended image 145.

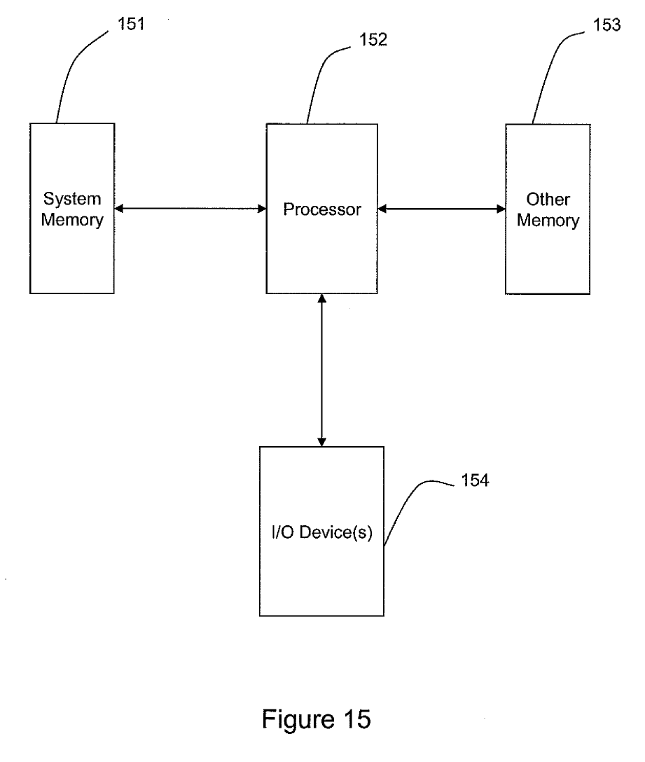

Various embodiments of the invention may comprise hardware, software, and/or firmware. FIG. 15 shows an exemplary system that may be used to implement various forms and/or portions of embodiments of the invention. Such a computing system may include one or more processors 152, which may be coupled to one or more system memories 151. Such system memory 151 may include, for example, RAM, ROM, or other such computer-readable media, and system memory 151 may be used to incorporate, for example, a basic I/O system (BIOS), operating system, instructions/software for execution by processor 152, etc. The system may also include further memory 153, such as additional RAM, ROM, hard disk drives, or other computer-readable storage media. Processor 152 may also be coupled to at least one input/output (I/O) interface 154. I/O interface 154 may include one or more user interfaces, as well as readers for various types of storage media and/or connections to one or more communication networks (e.g., communication interfaces and/or modems), from which, for example, software code may be obtained, e.g., by downloading such software from a computer over a communication network. Furthermore, other devices/media may also be coupled to and/or interact with the system shown in FIG. 15.

The above is a detailed description of particular embodiments of the invention. It is recognized that departures from the disclosed embodiments may be within the scope of this invention and that obvious modifications will occur to a person skilled in the art. It is the intent of the applicant that the invention include alternative implementations known in the art that perform the same functions as those disclosed. This specification should not be construed to unduly narrow the full scope of protection to which the invention is entitled.

What is claimed is:

1. A method of image registration, comprising:
performing, by an automated processing device, coarse alignment of at least two images to obtain coarse-aligned images;
performing coarse registration of the coarse-aligned images to obtain coarsely-registered images; and
performing fine registration of the coarsely-registered images to obtain finely-registered images; and
subtracting finely-registered images from each other to obtain a residual image.

2. The method of claim 1, further comprising preprocessing at least one of the images to perform at least one operation selected from the group consisting of normalization and segmentation.

3. The method of claim 2, wherein preprocessing further comprises obtaining a bone-suppressed image.

4. The method of claim 1, wherein coarse alignment comprises:
estimating a tilt;
estimating a translational offset; and
aligning the images based on the tilt and the translational offset.

5. The method of claim 4, further comprising using image segmentation to constrain the coarse alignment to be based on one or more regions of interest in the images.

6. The method of claim 1, wherein coarse registration comprises:
computing localized correlations between images; and
computing one or more displacements based on the localized correlations.

7. The method of claim 6, wherein computing one or more displacements comprises:
detecting a localized correlation that is below a predetermined value; and
determining a displacement value for the location represented by the localized correlation based on a displacement value of at least one neighboring displacement value.

8. The method of claim 6, wherein coarse registration further comprises:
applying displacement coherence; and
performing at least one localized elastic transformation.

9. The method of claim 6, wherein coarse registration further comprises utilizing a discriminant function to select one or more locations for computing one or more displacements.

10. The method of claim 1, wherein fine registration comprises performing at least one operation selected from the group consisting of an optical flow method and a correlation-based method.

11. The method of claim 10, wherein coarse registration further comprises:
applying displacement coherence; and
performing at least one localized elastic transformation.

12. The method of claim 10, wherein coarse registration further comprises utilizing a discriminant function to select one or more locations for computing one or more displacements.

13. The method of claim 1, further comprising postprocessing the residual image to improve the residual image for display.

14. The method of claim 13, wherein postprocessing comprises suppressing detail in an area of the residual image known to be subject to misalignment or to contain residuals that are not clinically significant.

15. The method of claim 13, wherein postprocessing comprises blending the residual image with an image from which the residual image was derived.

16. The method of claim 1, further comprising downloading software instructions that, if executed by a processing device, cause the processing device to perform said coarse alignment, coarse registration, fine registration, and subtracting.

17. The method of claim 1, further comprising at least one operation selected from the group consisting of displaying the residual image and printing the residual image.

18. A computer-readable medium containing software instructions that, if executed by a processing device, cause the processing device to implement a method of image registration comprising:
performing coarse alignment of at least two images to obtain coarse-aligned images;
performing coarse registration of the coarse-aligned images to obtain coarsely-registered images; and
performing fine registration of the coarsely-registered images to obtain finely-registered images; and
subtracting finely-registered images from each other to obtain a residual image.

19. The medium of claim 18, wherein the method further comprises preprocessing at least one of the images to perform at least one operation selected from the group consisting of normalization and segmentation.

20. The medium of claim 19, wherein preprocessing further comprises obtaining a bone-suppressed image.

21. The medium of claim 18, wherein coarse alignment comprises:
estimating a tilt;
estimating a translational offset; and
aligning the images based on the tilt and the translational offset.

22. The medium of claim 21, wherein the method further comprises using image segmentation to constrain the coarse alignment to be based on one or more regions of interest in the images.

23. The medium of claim 18, wherein coarse registration comprises:
computing localized correlations between images; and
computing one or more displacements based on the localized correlations.

24. The medium of claim 23, wherein computing one or more displacements comprises:
detecting a localized correlation that is below a predetermined value; and
determining a displacement value for the location represented by the localized correlation based on a displacement value of at least one neighboring displacement value.

25. The medium of claim 23, wherein coarse registration further comprises:
applying displacement coherence; and
performing at least one localized elastic transformation.

26. The medium of claim 23, wherein coarse registration further comprises utilizing a discriminant function to select one or more locations for computing one or more displacements.

27. The medium of claim 18, wherein fine registration comprises performing at least one operation selected from the group consisting of an optical flow method and a correlation-based method.

28. The medium of claim 27, wherein coarse registration further comprises:
applying displacement coherence; and
performing at least one localized elastic transformation.

29. The medium of claim 27, wherein coarse registration further comprises utilizing a discriminant function to select one or more locations for computing one or more displacements.

30. The medium of claim 18, wherein the method further comprises postprocessing the residual image to improve the residual image for display.

31. The medium of claim 30, wherein postprocessing comprises suppressing detail in an area of the residual image known to be subject to misalignment or to contains residuals that are not clinically significant.

32. The medium of claim 30, wherein postprocessing comprises blending the residual image with an image from which the residual image was derived.

33. The medium of claim 18, wherein the method further comprises at least one operation selected from the group consisting of displaying the residual image and printing the residual image.
